(19) United States
(12) Patent Application Publication
(10) Pub. No.: US 2008/0040553 A1
(43) Pub. Date: Feb. 14, 2008

(54) METHOD AND SYSTEM FOR GROUPING TRACKS FOR DESTAGING ON RAID ARRAYS

(76) Inventors: Kevin J. Ash, Tucson, AZ (US); Lokesh M. Gupta, Tucson, AZ (US); Thomas C. Jarvis, Tucson, AZ (US); Steven R. Lowe, Tucson, AZ (US)

Correspondence Address: DILLON & YUDELL, LLP, 8911 N CAPITAL OF TEXAS HWY, SUITE 2110, AUSTIN, TX, 78759, US

(21) Appl. No.: 11/464,113

(22) Filed: Aug. 11, 2006

(51) Int. Cl. G06F 13/00

(52) U.S. Cl. 711/133

(57) ABSTRACT

A method, system and processor for substantially reducing the write penalty (or latency) associated with writes and/or destaging operations within a RAID 5 array and/or RAID 6 array. When a write or destaging operation is initiated, i.e., when modified data is to be evicted from the cache, an existing data selection mechanism first selects the track of data to be evicted from the cache. The data selection mechanism then triggers a data track grouping (DTG) utility, which executes a thread to group data tracks, in order to maximize full stripe writes. Once the DTG algorithm completes the grouping of data tracks to complete a full stripe, a fall-stripe write is performed, and parity is generated without requiring a read from the disk(s). In this manner, the write penalty is substantially reduced, and the overall write performance of the processor is significantly improved.

### BACKGROUND OF THE INVENTION

1. Technical Field

The present invention generally relates to data storage systems, and in particular to Redundant Array of Independent Disks (RAID) data storage systems. Still more particularly, the present invention relates to efficiently handling write and/or destaging operations on RAID data storage systems.

2. Description of the Related Art

Conventional data processing systems perform memory access operations in a particular manner, based on the type of memory storage that is supported within the system. Typically, these memory storage are provided as a Redundant Array of Independent Disks (RAID).

RAID is a disk subsystem that is used to increase performance and/or provide fault tolerance for data storage operations. RAID is a set of two or more ordinary hard disks and a specialized disk controller that contains RAID functionality. RAID improves performance by disk striping, which interleaves bytes or groups of bytes across multiple drives, so more than one disk is reading and writing simultaneously. Fault tolerance is achieved by mirroring or parity.

There are several levels of RAID that are common in current computer systems, referred to as RAID level 0-6. Of these, RAID level 5 (RAID 5) and RAID level 6 (RAID 6) are among the most widely used. With RAID 5, data are striped across three or more drives for performance, and parity bits are used for fault tolerance. Also, parity information is distributed across all the drives. The parity bits from all drives but one are stored on a remaining drive, which alternates among the three or more drives.

Each level of RAID provides an indication of the latency involved in performing memory access operations, particularly write operations. In RAID 5, the data is interleaved blockwise over all of the disks and parity blocks are added and distributed over all the disks. This provides reliability and enables easy recovery of data when a single disk fails, by reading the parity block in other data blocks on the same stripe.

One drawback of the various RAID levels is the latency involved in completing standard write operations across multiple disks. With RAID 5 and RAID 6 arrays, in particular, severe penalties are realized when completing write operations (writes), as more disk input/outputs are required for each write operation. For example, a single write operation of a track may result in as many as four drive operations (ops) in case of RAID 5 arrays and six drive ops in case of RAID 6 arrays. Typically, a write operation to a block of a RAID 5 volume will be dispatched as two read operations and two write operations.

The above mentioned penalties are tied to the existing methods of completing writes in RAID arrays. Currently, two such methods are known and/or implemented.

The first method for completing writes in RAID arrays is based on accessing all of the data in the modified stripe and regenerating parity from that data. For a write that changes all the data in a stripe, parity may be generated without having to read from the disk. This generation of parity without reading from the disk is possible because the data for the entire stripe will be in the cache. This process is known in the art as full-stripe write. However, if the write only changes some of the data in a stripe, as commonly occurs, the missing data (i.e., the data the host application/device does not write) has to be read from the disks to create the new parity. This process is known in the art as partial-stripe write. The efficiency of the process of completing a partial-stripe write for a particular write operation depends on the number of drives in the RAID 5 (or RAID 6) array and what portion of the complete stripe is written.

The second method of updating parity is to determine which data bits were changed by the write operation and then change only the corresponding parity bits. This determination is completed by first reading the old data that is to be overwritten. The old data is then XORed with the new data that is to be written to generate a result. The result is a bit mask, which has a “1” in the position of every bit that has changed. This bit mask is then XORed with the old parity information from the array. The XORed operation results in the corresponding bits being changed in the parity information. Then, the new updated parity is written back to the array. Implementing this second method results in two reads, two writes and two XOR operations, and thus the second method is referred to as read-modify-write.

One of the drawbacks of the above two methods is that both methods are completed after the data set for a write is determined, resulting in partial-stripe writes and the associated latency. These methods thus have built in latencies when applied to the RAID 5 array and/or RAID 6 array. Given that increased processing speed via reduced latencies in memory access operations is a desired feature for data processing designs, the present invention recognizes the above drawbacks and provides a solution that minimizes the write penalty associated with writes to RAID 5 and RAID 6 arrays.

### SUMMARY OF THE INVENTION

Disclosed is a method, system and processor for substantially reducing the write penalty (or latency) associated with writes and/or destaging operations within a RAID 5 array and/or RAID 6 array. When a write or destaging operation is initiated, i.e., when modified data is to be evicted from the cache, an existing data selection mechanism first selects the particular block of data to be evicted from the cache. The data selection mechanism then triggers a data track grouping (DTG) utility, which executes a thread to group data tracks, in order to maximize full stripe writes.

The DTG utility implements a sequence of processes to attempt to construct full stripes from the data sets, based on the data track selected for eviction. Once the DTG algorithm completes the grouping of all data tracks that complete a full stripe, a full-stripe write is performed, and parity is generated without requiring a read from the disk. In this manner, the write penalty is substantially reduced, and the overall write performance of the processor is significantly improved.

In one embodiment, each rank within the cache is broken into sub-ranks, with each sub-rank being assigned a different thread to complete the grouping of data sets within that sub-rank. With this embodiment, each thread performing a grouping at a particular sub-rank is scheduled within a DTG queue of that sub-rank. The DTG algorithm then sequentially provides each scheduled thread with access to a respective, specific sub-rank to complete a grouping of data tracks within that sub-rank. The currently scheduled thread is provided a lock on the particular sub-rank until the thread completes its grouping operations. Then, when a stripe within the sub-rank includes all its data tracks, the data within the stripe is evicted as a full stripe write.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a pictorial representation of a computer system with a disk array in which the present invention may be implemented in accordance with a preferred embodiment of the present invention;

FIG. 2A is a block diagram of the internal components of a data processing system, within which the present invention may advantageously be implemented;

FIG. 2B is a block diagram representation of a cache subsystem designed with a data track grouping (DTG) mechanism/utility for grouping data sets within sub-ranks of a cache array, according to one embodiment of the invention; and

FIGS. 3A-3C are logical flow charts of the processes by which the data track grouping (DTG) algorithm enables the grouping of data to complete full stripe writes, in accordance with one embodiment of the invention.

### DETAILED DESCRIPTION OF AN ILLUSTRATIVE EMBODIMENT

The present invention provides a method, system and processor for substantially reducing the write penalty (or latency) associated with writes and/or destaging operations within a RAID 5 array and/or RAID 6 array. When a write or destaging operation is initiated, i.e., when modified data is to be evicted from the cache, an existing data selection mechanism first selects the track of data to be evicted from the cache. The data selection mechanism then triggers a data track grouping (DTG) utility, which executes a thread to group data tracks, in order to maximize full stripe writes. Once the DTG algorithm completes the grouping of data tracks to complete a full stripe, a full-stripe write is performed, and parity is generated without requiring a read from the disk(s). In this manner, the write penalty is substantially reduced, and the overall write performance of the processor is significantly improved.

In one embodiment, each rank within the cache is broken into sub-ranks, with each sub-rank being assigned a different thread to complete the grouping of data sets within that sub-rank. With this embodiment, each thread performing a grouping at a particular sub-rank is scheduled within a DTG queue of that sub-rank. The DTG algorithm then sequentially provides each scheduled thread with access to a respective, specific sub-rank to complete a grouping of data tracks within that sub-rank. The currently scheduled thread is provided a lock on the particular sub-rank until the thread completes its grouping operations. Then, when a stripe within the sub-rank includes all its data tracks, the data within the stripe is evicted as a full stripe write.

In the following detailed description of illustrative embodiments of the invention, specific illustrative embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

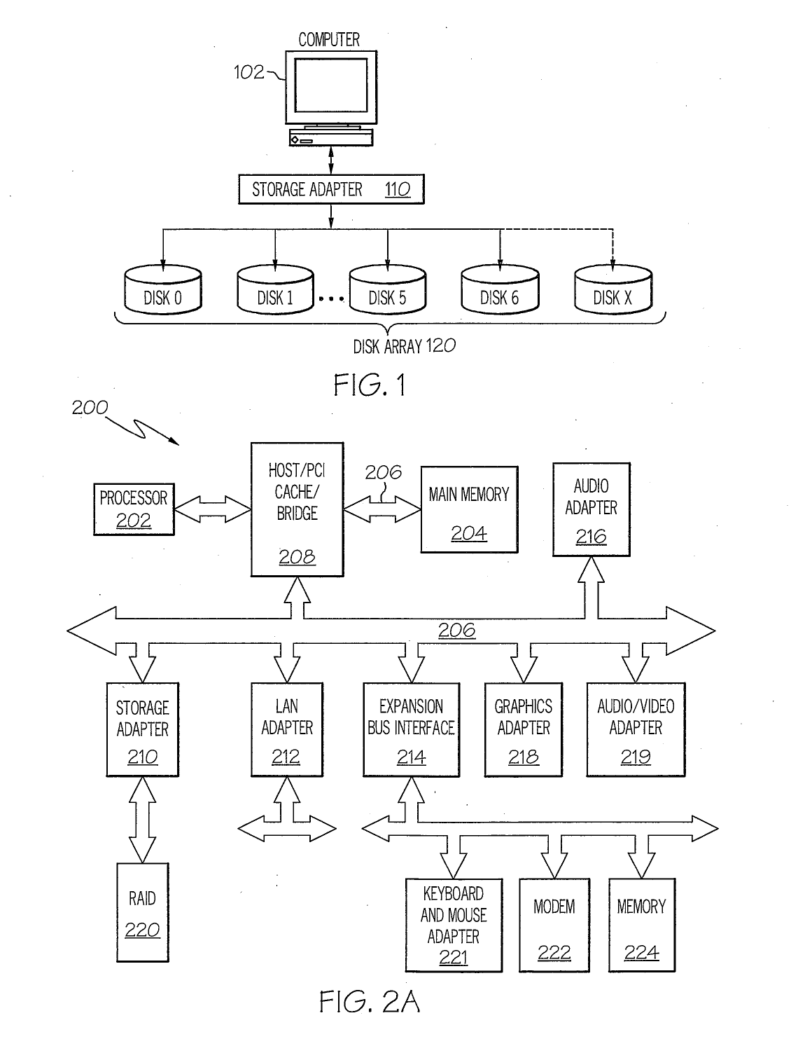

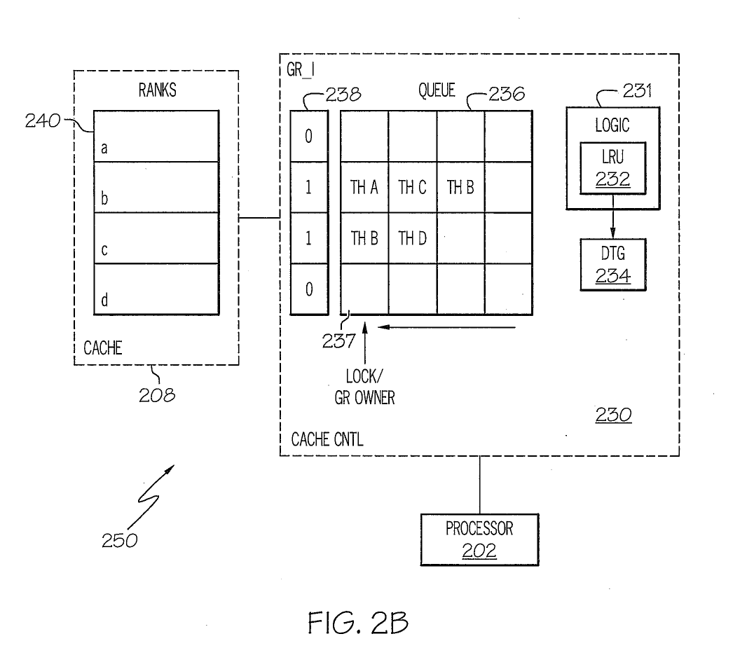

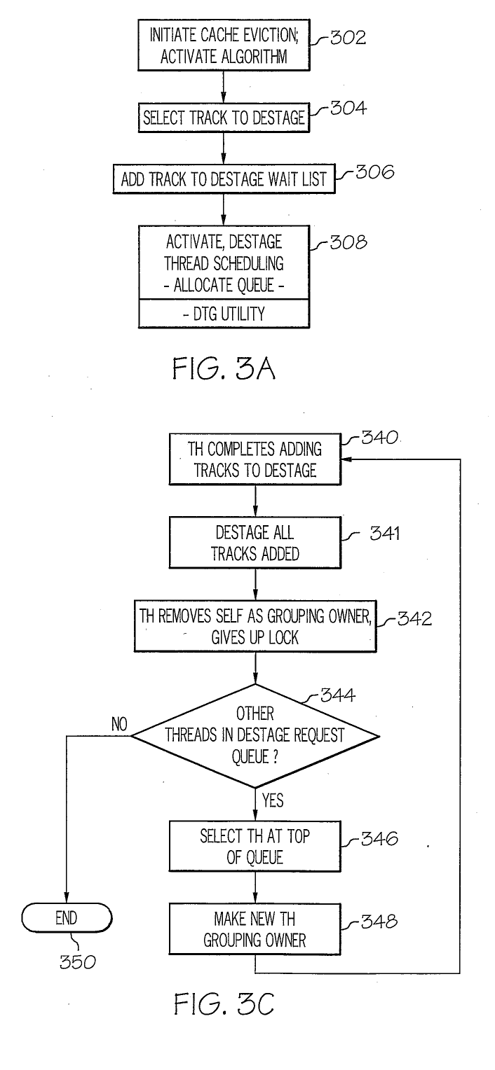

Within the descriptions of the figures, similar elements are provided similar names and reference numerals as those of the previous figure(s). Where a later figure utilizes the element in a different context or with different functionality, the element is provided a different leading numeral representative of the figure number (e.g., 1xx for FIG. 1 and 2xx for FIG. 2). The specific numerals assigned to the elements are provided solely to aid in the description and not meant to imply any limitations (structural or functional) on the invention.

It is also understood that the use of specific parameter names are for example only and not meant to imply any limitations on the invention. The invention may thus be implemented with different nomenclature/terminology utilized to describe the parameters herein, without limitation.

With reference now to the figures and in particular with reference to FIG. 1, a pictorial representation of a computer system with a Random Array of Independent Disks (RAID) system attached is depicted in accordance with one embodiment of the present invention. Computer 102 is depicted connected to disk array 120 via storage adapter 110. Computer 102 may be implemented using any suitable computer, such as an IBM eServer computer or IntelliStation computer, which are products of International Business Machines Corporation, located in Armonk, N.Y.

In the depicted example, disk array 120 includes multiple disks, of which disk 0, disk 1, disk 5, and disk 6, are illustrated. However, more or fewer disks may be included in the disk array within the scope of the present invention. For example, a disk may be added to the disk array, such as disk X in FIG. 1. In accordance with the described embodiments of the present invention, RAID system (120), including computer 102 and storage adapter 110, are configured to operate as a RAID level 5 system, which stripes data across the drives for performance and utilizes parity bits for fault tolerance.

With reference now to FIG. 2A, a block diagram of a data processing system is shown in which the present invention may be implemented. Data processing system 200 is an example of computer 102 in FIG. 1, in which storage adapter 210 operates with a cache controller (not shown) to implement features of the present invention. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory (see FIG. 2B) for processor 202. Additional connections to PCI local bus 206 may be made through direct component interconnection or through add-in boards.

In the depicted example, storage adapter 210, local area network (LAN) adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 221, modem 222, and additional memory 224. Storage adapter 210 provides a connection for RAID 220, which comprises hard disk drives, such as disk array 120 in FIG. 1. Typical PCI local bus implementations will support three or four PCI expansion slots or add-in connectors.

Depending on implementation, RAID 220 in data processing system 200 may be (a) SCSI (“scuzzy”) disks connected via a SCSI controller (not specifically shown), or (b) IDE disks connected via an IDE controller (not specifically shown), or (3) iSCSI disks connected via network cards. The disks are configured as one or more RAID 5 disk volumes. In alternate embodiments of the present invention, RAID 5 controller and cache controller, enhanced by the various features of the invention, are implemented as software programs running on a host processor. Alternatively, the present invention may be implemented as a storage subsystem that serves other computers and the host processor is dedicated to the RAID controller and cache controller functions enhanced by the invention.

An operating system runs on processor 202 and is used to coordinate and provide control of various components within data processing system 200 in FIG. 2A. The operating system may be a commercially available operating system such as AIX, which is available from IBM Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drives, and may be loaded into main memory 204 for execution by processor 202.

Those of ordinary skill in the art will appreciate that the hardware depicted in FIGS. 1 and 2A may vary depending on implementation. Other internal hardware or peripheral devices, such as flash read-only memory (ROM), equivalent nonvolatile memory, or optical disk drives and the like, may be used in addition to or in place of the hardware depicted in FIGS. 1 and 2A. Also, the processes of the present invention may be applied to a multiprocessor data processing system. Thus, the depicted example is not meant to imply architectural limitations with respect to the present invention.

Turning now to FIG. 2B, there is illustrated an example cache subsystem according to one embodiment of the invention. Cache subsystem 250 comprises cache 208 (or cache array) coupled to cache controller 230, which is in turn coupled to processor 202. Cache 208 includes a plurality of arrays of data, of which a single rank 240 is illustrated. Rank 240 is further illustrated as divided into four (4) sub-ranks (a-d), for reasons described below. Cache controller 230 comprises standard cache controller logic 231 including least recently used (LRU) algorithm 232 for selecting a data track for eviction from cache 208. Additionally, according to the illustrative embodiment of the invention, cache controller 230 also comprises grouping on/off index 238 and DTG queue 236, each utilized to provide specific functionality during execution of the invention, as described below. Finally, cache controller 230 includes DTG mechanism 234 (also referred to herein as DTG utility or DTG algorithm), which enables/controls the various grouping operations that occur when implementing the invention. In one embodiment, both grouping on/off index 238 and DTG queue 236 are software constructs generated by DTG mechanism 234 when a data eviction is triggered within the cache.

Notably, the illustrative embodiment provides DTG mechanism with the ability to logically divide the larger rank 240 into sub-ranks (e.g., a-d) up to a per stripe granularity. In an alternate embodiment in which each rank is handled as a single block and provided a single DTG queue (236), (referred to as rank-level grouping, as opposed to sub-rank-level grouping of the illustrative embodiment), only a single thread is provided to group tracks for destage on the entire rank. With this implementation, the grouping process (thread) takes a lock for the entire rank while grouping data tracks. Of course, a potential problem with this approach is that as rank sizes get larger and larger, all destages for a particular rank must contend for the lock. Thus, while the features of the invention are fully applicable to complete the grouping function at the rank-level, this rank-level implementation may potentially result in the locking mechanism itself to become a bottleneck for destage grouping, and potentially for any destage, for the rank.

Thus, according to the illustrative embodiment, sub-rank-level grouping is provided, and the “grouping in progress” indication, described in greater details below, refers to a sub-rank granularity for grouping data tracks. For example, the lower numbered half of the tracks in an example rank could have a separate “grouping in progress” indicator from the higher numbered half. The embodiment illustrated by FIG. 2B divides the rank into four sub-ranks, each having an associated “grouping in progress” indicator within grouping on/off index 238.

As mentioned above, the granularity of the sub-ranks may be as small as a single stripe. In the single stripe case, there is an array of “grouping in progress” indicators, with each indicator in the array corresponding to a single stripe in the rank, and functioning as the indicator for the grouping process for that stripe. The determination of how granular the indication should be takes into consideration the amount of space used by the array of indicators (index 238) and associated DTG queue 236, as well as the bandwidth of the storage adapter. In general, the illustrative embodiments provide a pre-calculated number of separate indicators to saturate the storage adapter with grouped destages.

Grouping on/off index 238 is utilized to indicate whether or not a grouping operation is being conducted on a particular sub-rank within rank 240 (cache 208). According to the illustrative embodiment, grouping on/off index 238 is an array with single bits assigned to each sub-rank that may be subject to track grouping operations. A value of “1” indicates that grouping is occurring for the particular sub-rank, while a value of “0” indicates that no grouping operation is being conducted at that sub-rank. As shown, sub-ranks b and c have ongoing grouping operations, and thus have a value of 1 within their respective index, while sub-ranks a and d have a value of 0 within their respective index indicating that sub-ranks a and d do not have ongoing groupings operation.

Entries within DTG queue 236 correspond to the thread or threads assigned to perform the grouping of data within a particular sub-rank. As shown, both ranks b and c, which have grouping index values of 1, have at least one thread within their respective queue. Within the figure, queues run horizontally from right to left, with the leftmost position in each queue being the position that holds the currently executing thread. During operation of the invention, this first position also represents the thread with a current lock on the specific sub-rank. This thread with the lock is considered the grouping owner and is the sole thread that is able to perform grouping on the particular data set, while that thread maintains the lock. DTG queue 236 may be a FIFO (first in first out) and each new thread assigned to perform grouping for that sub-rank is scheduled behind the last thread entered within that queue.

Notably, DTG queue 236 is shown with a depth of four (4) entries, and multiple threads are illustrated within queues associated with sub-ranks b and c. However, it is contemplated that alternate embodiments of the invention may be provided in which a single entry queue is utilize or a different number of multiple-entries are provided within DTG queue 236. Also, while four queues are illustrated for the particular rank 240, corresponding to the four sub-ranks, different numbers of queues will be utilized within alternative embodiments in which different numbers of sub-ranks are provided. The number of queues provided is only limited by the total number of stripes within rank 240, as the smallest grouping size is that required for a full stripe write. The granularity provided is thus based on system design, given the added real estate required for maintaining a larger number of queues and associated grouping on/off indices, when rank is logically divided down into multiple sub-ranks.

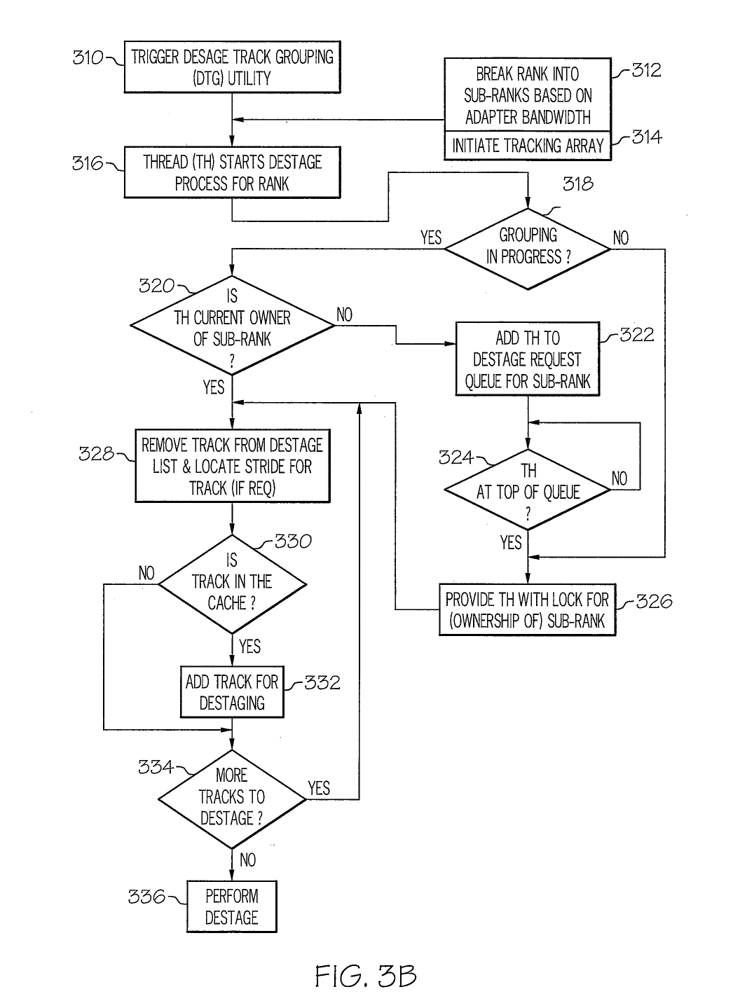

Utilizing the structures within cache controller 230 and cache 208 in a system, such as data processing system 200, write operations and/or destaging operations by which a data line (stripe) is removed from the cache, is completed with decreased latency. The processes provided when implementing the invention to remove modified data from the cache is depicted within FIGS. 3A-3C. These figures are described below.

A major component of the invention is the enhancement of the cache controller to include the above described components, namely, DTG mechanism 234, DTG queue 236, and grouping on/off index 238. DTG mechanism 234 utilizes the other components within an algorithm that enables the grouping of tracks, in order to maximize full stripe writes. Thus, whenever the processor or cache controller initiates the process for evicting modified data from the cache, the DTG mechanism for grouping data tracks provides the enhancements that result in the decrease latency of completing the write (data eviction) operation.

Within cache subsystem 250, several different triggers may cause the eviction of modified data from the cache. These triggers are known in the art and are only tangential to the invention and thus not described in detailed herein. Once an eviction is triggered however, cache controller implements a selection mechanism to determine which data should be evicted from the cache. There are several known selection mechanisms, and the invention is described with specific reference to the Least Recently Used (LRU) algorithm, which is illustrated within FIG. 2B. Using the LRU algorithm, data which has been least recently used are selected for eviction from cache 208. Any other selection mechanism may be utilized within other implementations of the invention, and the use of LRU is provided solely for illustration and not meant to be read as implying any limitation on the general concepts within the invention.

The invention provides a DTG algorithm that is utilized in conjunction with selection mechanisms, such as the LRU algorithm, for determining data tracks to be evicted. During implementation, the processor or cache controller first determines a data track to be evicted, via the existing selection algorithm. Based on this data track, the DTG algorithm then attempts to construct a full stripe of data tracks. According to the invention, the primary rational for triggering/implementing this grouping of data is to provide full stripes for eviction, since with full-stripes, parity is generated without having to perform a read from the disk. There is thus no write penalty, and write performance is significantly improved.

FIGS. 3A-3C are flow charts of various parts of the process by which grouping of data into full stripes are performed prior to data eviction, according to embodiments of the invention. The method for grouping tracks for destaging is clearly illustrated by these flow charts. Notably, the DTG algorithm is activated when the DTG utility is triggered by selection of modified data within a cache to evict. The cache eviction method (e.g., the LRU algorithm) selects a unit of data for eviction. According to the invention, a unit of data generally refers to a page or a track of data. The processes below are described with the unit of data being a track and the cache eviction method being LRU.

With these assumptions, FIG. 3A illustrates the process by which the track of data is selected for destaging. The process begins at block 302 at which the cache initiates a cache eviction and activates the LRU algorithm. The LRU algorithm finds/selects a LRU track for eviction, as shown at block 304. When a preset threshold for completing a destage operation is not reached, the selected track is removed and added to a Destage Wait List. Then the LRU algorithm triggers DTG algorithm to generate and schedule a thread, (“DestageThread”). Thus, at block 306, the LRU algorithm adds the selected track to the destage waiting list. With the LRU track identified and added to the destage list, the LRU triggers the DTG algorithm, which activates the destage track grouping functions, as shown at block 308. Generally, the track grouping functions provides one or more threads (DestageThread) for grouping tracks within a stripe. According to the invention, this thread will locate other tracks in the same stripe as the selected (LRU) track and group these other tracks with the selected track prior to destaging. In the described embodiment, so as to avoid possible grouping conflicts, no other threads are allowed to begin grouping tracks within the specific sub-rank, while a grouping process is ongoing by a previous thread.

FIG. 3B provides a more detailed description of the process of thread grouping functions by DestageThread, according to one embodiment. The thread grouping functions are associated with the DTG utility and provide and/or utilize the DTG queues 236 and grouping on/off indicators 238 to complete the thread grouping functions. Thus, at block 310, the DTG algorithm is activated (following the processing at block 308). Then, based on the bandwidth of the device adapter (e.g., the controller for the storage arrays), the rank is broken into sub-ranks at block 312, and the tracking array is provided, as shown at block 314. The DestageThread then starts the destage process for the sub-rank to which the tack is associated, as depicted at block 316. A decision is made at block 318 whether there is a grouping already in progress for that sub-rank. This decision involves checking the grouping on/off indicator (bit) 236 for that sub-rank, where a value of 1 indicates an ongoing grouping already in progress and a 0 value indicates no grouping in progress.

If there is no grouping in progress, then the DestageThread is provided with a lock for (i.e., ownership of) the sub-rank to complete the DestageThread's grouping of data, as indicted at block 326. If, however, the indicator indicates that there is a grouping in progress, then a next decision is made at block 320 whether the DestageThread has the lock (or is the current owner) of the sub-rank for grouping purposes. If the DestageThread is not the current owner, when there is a grouping in progress, the DTG utility places the thread to the DTG queue 236 for that sub-rank, as shown at block 322. A periodic check is made at block 324 whether the DestageThread reaches the top of the queue. When the DestageThread reaches the top of the DTG queue 236, the DestageThread is provided the lock for the corresponding sub-rank at block 326. Notably, in a multi-threading environment, the invention provides a plurality of locks for a single rank, when divided into sub-ranks that may be subject to concurrent grouping of tracks within respective sub-ranks.

Returning to decision block 320, when the DestageThread is the current owner of the sub-rank, the DestageThread removes the track from the destage list and locates the stripe for the track, as provided at block 328. Then, for all other tracks in the particular stripe, a check is made at block 330 whether these other tracks are also in the cache. If any of these other tracks are in the cache, these other tracks are added to the stripe for destaging, as shown at block 332.

Once DestageThread completes the adding of the various tracks for destaging, Destage Thread checks at block 334 whether there are any more tracks to destage. When there are no more tracks to destage, DTG utility performs the destage process for the particular stripe(s), as shown at block 336.

Actual performance of the destage process following the compiling (adding) of tracks to the stripe(s) for destaging is provided by FIG. 3C. The process begins at block 340 which shows the DestageThread completing the addition of data tracks to the stripe in preparation for the destage operation. Destage Thread performs the destaging of the tracks in full stripe writes, as shown at block 341. DestageThread then removes itself as the grouping owner and gives up the lock, as indicated at block 342. A decision is made at block 344 whether there are other destage threads in the DTG queue 236. If there are other threads, the thread at the top of the queue is selected at block 346 and provided ownership of (a lock on) the sub-rank for grouping of tracks, at block 348. If there are no other threads in the DTG queue 236 for that sub-rank, the process concludes at termination block 350.

In one implementation, the thread that is provided ownership is actually removed from the queue so that another thread my occupy the pole position within the queue, but is not yet provided the lock and corresponding ownership of the particular sub-rank. Once the thread is removed, the DTG utility then schedules the DestageThread. Finally, the DTG algorithm (via respective threads) destages all the tracks that were added with the destaging processes.

The described invention provides a novel method of grouping tracks for destaging in order to minimize the write penalty in case of RAID 5 and RAID 6 arrays. The present invention provides a technique to improve performance while destaging data tracks. Specifically, the invention allows one thread a lock on a sub-rank to try to group tracks within the sub-rank, without providing any hint as to which tracks may be fully in the cache. The invention enables the data set to be chosen so that the write penalty is minimized. This selective choosing of the data set substantially improves the overall performance of the first and the second methods of completing a write to a RAID 5 or RAID 6 array.

As provided by the claims, the invention generally provides a method, cache subsystem, and data processing system for completing a series of processes during data eviction from a cache to ensure that a smallest write penalty is incurred. The cache controller determines (via existing methods known in the art) when modified data is to be evicted from the cache. The cache controller activates an existing selection mechanism (e.g., LRU) to identify the particular unit of modified data to be evicted. The selection mechanism then triggers a destage thread grouping (DTG) utility, which initiates a data grouping process that groups individual units of data into a larger unit of data that incurs a smallest amount of write penalty when completing a write operation from the cache. The particular data is a member of the larger unit of data along with the other individual units of data, and each of the individual units of data incur a larger write penalty than the larger unit of data.

The DTG utility completes the grouping process by first generating a thread to perform the data grouping process. The DTG utility then determines if there is no previous grouping process ongoing for the specific portion of a cache array in which the particular data exists. The determination is completed by checking a respective bit of the grouping on/off indicator that is maintained by the DTG utility within the cache controller. When there is no ongoing grouping process (i.e., the lock is available for that portion of the cache array), the DTG algorithm provides the thread with a lock on the portion of the cache array to complete said grouping process. The thread then initiates the grouping process within that portion of the cache array. The cache controller (via the thread) performs the write operation of the larger unit of data generated from the grouping process. The larger unit of data is written to the storage device. Once the thread completes the grouping process, the thread stops executing, and the thread releases the lock on the portion of the cache array of data from the thread.

When the DTG utility determines that a previous grouping process is ongoing for the portion of the cache array in which the particular data exists, however, DTG utility places the thread into a DTG queue 236 corresponding to that portion of the cache array. The DTG utility monitors for when the thread reaches the top of the DTG queue 236. Then, once the previous grouping process has completed and the previous thread releases the lock, the DTG utility provides the thread with the lock on the portion of the cache array, and the thread begins the data grouping process for the particular data.

In addition to the above features, the DTG utility also provides a granular approach to completing the grouping process. Thus, the DTG utility divides the rank of data into a plurality of sub-ranks, where each sub-rank represents the portion of the array that may be targeted by a destage grouping thread. Then, the DTG utility granularly assigns to one or more sub-ranks specific destage grouping threads, with different ones of the particular data to be evicted. Thus, DTG utility initiates different grouping processes within the one or more sub-ranks. The DTG utility then performs the grouping process and subsequent write operation on a sub-rank level, and the specific destage grouping thread assigned to a particular sub-rank groups the larger unit of data solely within the particular sub-rank.

As a final matter, it is important that while an illustrative embodiment of the present invention has been, and will continue to be, described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. In a data processing system having a storage device and a cache subsystem with a cache and a cache controller, a method comprising:
determining when data is to be evicted from the cache;
activating a selection mechanism to identify a particular unit of data to be evicted;
when the particular unit of data is identified, initiating a data grouping process that groups individual units of data into a larger unit of data that incurs a smallest amount of write penalty when completing a write operation from the cache, wherein the particular data is a member of the larger unit of data along with the other individual units of data, and each of said individual units of data incur a larger write penalty than the larger unit of data.

2. The method of claim 1, wherein said grouping process comprises:
generating a thread to perform the data grouping process;
determining whether a previous grouping process is ongoing for a portion of the cache array in which the particular data exists;
when a previous grouping process is not ongoing for the portion of a cache array in which the particular data exists:
providing said thread with a lock on the portion of the cache array to complete said grouping process; and
initiating said grouping process via said thread while said thread has the lock; and
when the thread completes the grouping process:
stopping said thread;
removing the lock on the portion of data from the thread; and
writing the larger unit of data generated from the grouping process to the storage device.

3. The method of claim 2, further comprising:
when a previous grouping process is ongoing for the portion of the cache array in which the particular data exists:
placing said thread into a DTG queue generated for that portion of the cache array; and
monitoring for when said thread reaches the top of the DTG queue and the previous grouping process has completed and released the lock;
providing the thread with the lock on the portion of the cache array; and
initiating the data grouping process for that thread.

4. The method of claim 1, wherein said cache comprises at least one rank, said method further comprising:
dividing said rank into a plurality of sub-ranks, each sub-rank representing a portion of the sub-array that may be targeted by a destage grouping thread;
granularly assign to one or more of sub-ranks specific destage grouping threads with different ones of particular data to initiate different grouping processes within the one or more sub-ranks; and
performing the grouping process and write operation on a sub-rank level, wherein the specific destage grouping thread assigned to a particular sub-rank groups the larger unit of data solely within the sub-rank.

5. The method of claim 4, wherein said data processing system comprises a storage adapter for accessing the storage device, said storage adapter supporting a specific bandwidth of write data, said method further comprising:
dividing the rank into sub-ranks based on the bandwidth of write data supported by the storage adapter, wherein maximum data is provided for a write operation of the full sub-rank.

6. The method of claim 1, wherein said dividing of the rank into sub-ranks further comprises:
sizing the sub-ranks to a size of the larger unit of data that incurs the smallest write penalty for maximum granularity in the grouping process; and
granularly assigning separate destage grouping threads to specific ones of each of said larger unit of data with an associated particular data that is selected for eviction from the cache.

7. The method of claim 1, wherein said storage system is one of a Redundant Array of Independent Disk (RAID) 5 and RAID 6 array, said larger unit of data is a full stripe, said writing further comprises completing a full stripe write of the larger unit of data following the grouping process.

8. The method of claim 1, wherein the selection mechanism is a least recently used (LRU) algorithm.

9. A cache subsystem comprising:
a cache array;
coupling means for connecting the cache subsystem to a processor;
coupling means for connecting the cache subsystem to an external storage device; and
a cache controller associated with the cache array and which includes:
a selection mechanism for selecting data to evict from the cache array;
a destage grouping utility that responsive to a trigger from the selection mechanism that a particular unit of data has been selected for eviction, initiates a data grouping process that groups individual units of data into a larger unit of data that incurs a smallest amount of write penalty when completing a write operation from the cache, wherein the particular data is a member of the larger unit of data along with the other individual units of data, and each of said individual units of data incur a larger write penalty than the larger unit of data.

10. The cache subsystem of claim 9, wherein said grouping utility comprises:
a DTG queue for sequentially queuing one or more threads that are generated to perform a grouping process at the portion of the cache array in which the particular data exists;
a grouping on/off index for indicating whether a previous thread is performing an ongoing grouping process at the portion of the cache array in which the particular data exists; and
logic for completing said grouping process via a series of processes including:
generating a thread to perform the data grouping process;
determining whether a previous grouping process is ongoing for the portion of the cache array in which the particular data exists;
when a previous grouping process is not ongoing for a portion of a cache array in which the particular data exists:
providing said thread with a lock on the portion of the cache array to complete said grouping process; and
initiating said grouping process via said thread while said thread has the lock; and
when the thread completes the grouping process:
stopping said thread;
removing the lock on the portion of data from the thread; and
writing the larger unit of data generated from the grouping process to the storage device.

11. The cache subsystem of claim 10, wherein said grouping utility further comprises logic for:
when a previous grouping process is ongoing for the portion of the cache array in which the particular data exists:
placing said thread into a DTG queue generated for that portion of the cache array; and
monitoring for when said thread reaches the top of the DTG queue and the previous grouping process has completed and released the lock;
providing the thread with the lock on the portion of the cache array; and
initiating the data grouping process for that thread.

12. The cache subsystem of claim 9, wherein said cache comprises at least one rank, and said grouping utility further comprises logic for:
dividing said rank into a plurality of sub-ranks, each sub-rank representing a portion of the sub-array that may be targeted by a destage grouping thread;
granularly assign to one or more of sub-ranks specific destage grouping threads with different ones of particular data to initiate different grouping processes within the one or more sub-ranks; and
performing the grouping process and write operation on a sub-rank level, wherein the specific destage grouping thread assigned to a particular sub-rank groups the larger unit of data solely within the sub-rank.

13. The cache subsystem of claim 12, wherein said cache controller comprises means for dynamically determining a bandwidth of a later connected storage adapter coupled to he coupling means, said later connected storage adapter supporting a specific bandwidth of write data, said grouping utility further comprises logic for:
dividing the rank into sub-ranks based on the bandwidth of write data supported by the storage adapter, wherein maximum data is provided for a write operation of the full sub-rank.

14. The cache subsystem of claim 9, wherein logic for said dividing of the rank into sub-ranks further comprises logic for:
sizing the sub-ranks to a size of the larger unit of data that incurs the smallest write penalty for maximum granularity in the grouping process; and
granularly assigning separate destage grouping threads to specific ones of each of said larger unit of data with an associated particular data that is selected for eviction from the cache.

15. The cache subsystem of claim 9, wherein said larger unit of data is a full stripe, said logic for writing further comprises logic for completing a full stripe write of the larger unit of data following the grouping process.

16. The cache subsystem of claim 1, wherein the selection mechanism is a least recently used (LRU) algorithm.

17. A data processing system having a cache subsystem according to claim 9, and further comprising:
the processor;
the data storage;
the later connected storage adapter;
wherein the data storage is one of a random array of independent disks (RAID) 5 and RAID 6 array.

18. A data processing system having a cache subsystem according to claim 11.

19. A data processing system comprising:
a processor;
a data storage having an associated storage adapter designed with a specific bandwidth for processing write data;
a cache subsystem coupled to the processor and the storage adapter and including:
a cache array;
a cache controller associated with the cache array and which includes:
a least recently used (LRU) algorithm for selecting data to evict from the cache array;
a destage grouping utility that responsive to a trigger from the selection mechanism that a particular unit of data has been selected for eviction, initiates a data grouping process that groups individual units of data into a larger unit of data that incurs a smallest amount of write penalty when completing a write operation from the cache, wherein the particular data is a member of the larger unit of data along with the other individual units of data, and each of said individual units of data incur a larger write penalty than the larger unit of data;
a DTG queue for sequentially queuing one or more threads that are generated to perform a grouping process at the portion of the cache array in which the particular data exists;
a grouping on/off index for indicating whether a previous thread is performing an ongoing grouping process at the portion of the cache array in which the particular data exists; and
wherein said grouping utility comprises logic for completing said grouping process via a series of processes including:
generating a thread to perform the data grouping process;
determining whether a previous grouping process is ongoing for the portion of the cache array in which the particular data exists;
when a previous grouping process is not ongoing for a portion of a cache array in which the particular data exists:
providing said thread with a lock on the portion of the cache array to complete said grouping process; and
initiating said grouping process via said thread while said thread has the lock; and
when the thread completes the grouping process:
stopping said thread;
removing the lock on the portion of data from the thread; and
writing the larger unit of data generated from the grouping process to the storage device; and
when a previous grouping process is ongoing for the portion of the cache array in which the particular data exists:
placing said thread into a DTG queue generated for that portion of the cache array; and
monitoring for when said thread reaches the top of the DTG queue and the previous grouping process has completed and released the lock;
providing the thread with the lock on the portion of the cache array; and
initiating the data grouping process for that thread.

20. The data processing system of claim 19, wherein said cache array comprises at least one rank, and said grouping utility further comprises logic for:
dividing said rank into a plurality of sub-ranks, each sub-rank representing a portion of the sub-array that may be targeted by a destage grouping thread;
granularly assign to one or more of sub-ranks specific destage grouping threads with different ones of particular data to initiate different grouping processes within the one or more sub-ranks;
performing the grouping process and write operation on a sub-rank level, wherein the specific destage grouping thread assigned to a particular sub-rank groups the larger unit of data solely within the sub-rank;
dividing the rank into sub-ranks based on a bandwidth of write data supported by the storage adapter, wherein maximum data is provided for a write operation of the full sub-rank;
sizing the sub-ranks to a size of the larger unit of data that incurs the smallest write penalty for maximum granularity in the grouping process; and
granularly assigning separate destage grouping threads to specific ones of each of said larger unit of data with an associated particular data that is selected for eviction from the cache.
